(19) United States
(12) Patent Application Publication
(10) Pub. No.: US 2004/0265504 A1
(43) Pub. Date: Dec. 30, 2004

(54) Non-metalic substrate having an electostatically applied activatable powder adhesive

(76) Inventors: Christophe Magnin, Lyon (FR); Susan Burdett, Surrey (GB); Robert Koelliker, Oberkirch (CH); David Duckworth, Lancashire (GB)

Correspondence Address: Thomas F. Roland, NATIONAL STARCH AND CHEMICAL COMPANY, P.O. Box 6500, Bridgewater, NJ, 08807-0500, US

(21) Appl. No.: 10/608,163

(22) Filed: Jun. 27, 2003

(51) Int. Cl. B05D 1/04

(52) U.S. Cl. 427/458; 156/273.1; 156/283; 156/284; 156/275.7

(57) ABSTRACT

The invention relates to a method for electrostatically attaching a polymeric polymer powder adhesive to a non-metallic substrate. The invention also relates to the substrate having deposited thereon by electrostatic means a polymer powder adhesive, which can be activated for adhesion or cohesion. The method is especially useful for depositing powdered adhesive onto paper or plastic, which can be activated by heat, water, radiation, or other means. The activated adhesive allows the non-metallic substrate to then adhere to another substrate, or to itself.

### FIELD OF THE INVENTION

The invention relates to a method for electrostatically attaching a polymeric polymer powder adhesive to a non-metallic substrate. The invention also relates to the substrate having deposited thereon by electrostatic means a polymer powder adhesive, which can be activated for adhesion or cohesion. The method is especially useful for depositing powdered adhesive onto paper or plastic, which can be activated by heat, water, radiation, or other means. The activated adhesive allows the non-metallic substrate to then adhere to another substrate, or to itself.

### BACKGROUND OF THE INVENTION

Pre-applied adhesives on paper or plastic substrates provide consumers the convenience of being able to seal a finished product by activating the adhesive at the point of use, such as by applying moisture, pressure, radiation, or heat. The adhesive is generally applied to the substrate as a liquid, and is subsequently dried, as shown for example in U.S. Pat. No. 5,965,646.

There are several disadvantages of using a liquid adhesive composition, as compared with the use of a powder. The biggest disadvantage is that the liquid adhesive must be dried onto the substrate, which generally requires costly expenditures of both energy and time. Additionally, liquid adhesives are more costly to transport and store than a dry powder. Even powder adhesives that are redispersible in water, still suffer from the costs associated with the drying step once applied to the substrate.

Powdered coatings are known, which are electrostatically applied to metallic substrates in the automobile industry. The powder coating used is generally a thermoplastic, cross-linkable polymer. The powdered polymer composition is usually charged by friction or induction, then applied to the metallic substrate by means of an applied electric field. The powdered polymer coating is then cured or fused to obtain a uniform coating.

Powders have also been directly applied to non-metallic substrates. In U.S. Pat. No. 6,136,732 a thermosetting powder adhesive is blended with a thermoplastic web adhesive and applied to a non-woven web, for use in adhering incompatible materials.

U.S. Pat. No. 6,455,110 describes the application of polymer powder coatings to non-conductive plastics by applying a conductive layer on or adjacent to the plastic part. The method worked best with materials that were capable of attaining sufficient conductivity, such as polyamides. The powder coating is then cured to form a coated plastic substrate.

Other methods have been developed for applying a powder coating to a non-conducting substrate, including heating the substrate so the powder will at least partially cure on contact, and by applying a conductive primer to the substrate, followed by the application of charged powder. U.S. Pat. No. 6,270,853 describes the application to the non-conducting substrate of an anti-static layer, such as a fatty amine salt, followed by electrostatic disposition of a polymer powder. U.S. patent application Ser. No. 2002/0160123 describes the deposition of an electrostatic coating on a plastic.

Powder coatings have been applied electrostatically to pharmaceutical substrates by the application of an electric field and an electric potential difference between a tablet core and the powder material, as described in U.S. Pat. No. 6,406,738.

In each of the references above, a polymeric powder was applied to a substrate, then cured to form a coating. There was no reference to reactivating the powder to form a functional adhesive.

Heterogeneous polymers having cationic functionality are described in WO 00/05275, WO 00/05283, and WO 00/05276. These polymers contain cationic functionality either by the use of a cationic monomer, or through the incorporation of a cationic protective colloid in forming an emulsion copolymer. The copolymer is then dried to form a re-dispersible powder.

There is a need for an adhesive that can be applied to a substrate in powder form by an electrostatic process, and the powder adhesive is capable of being reactivated at a latter time to function as an adhesive.

Surprisingly it has been found that a powder adhesive can be applied to a non-metallic substrate, such as paper or plastic, to form a pre-applied adhesive layer that can be activated at a latter time to adhere two surfaces together.

### SUMMARY OF THE INVENTION

The present invention is directed to a method for electrostatically applying a powder adhesive formulation to a non-metallic substrate comprising:

a) forming a powder adhesive composition comprising a polymer:

b) applying an electrostatic charge to the powder;

c) depositing the charged powder onto a non-metallic substrate,

wherein the electrostatically-applied adhesive is capable of being reactivated and used as an adhesive.

The present invention is also directed to a method for bonding a non-metallic substrate to another substrate comprising:

a) forming a powder adhesive formulation comprising a polymer:

b) applying an electrostatic charge to the powder adhesive formulation;

c) depositing the charged powder onto a non-metallic substrate, activating said powder adhesive formulation, and contacting the activated adhesive-containing non-metallic substrate with a second substrate;

d) allowing the adhesive between the two substrates to cure, producing bonded substrates.

The invention is further directed to a powder adhesive coated non-metallic substrate comprising a non-metallic substrate having directly deposited thereon by electrostatic forces, a powder adhesive capable of being activated to exhibit adhesive properties.

### DETAILED DESCRIPTION OF THE INVENTION

The present invention relates to a method for electrostatically applying a powdered adhesive to a non-metallic substrate, the adhesive being capable of activation at a latter time for use in bonding the non-metallic substrate to another substrate or to another part of the same substrate.

The powder adhesives useful in the present invention include any adhesive in a powder form, which is capable of being reactivated at some time in the future. The adhesive powder includes one or more polymers and may optionally be formulated with adjuvants typically found in an adhesive formulation, such as, but not limited to, tackifiers, adhesion promoters, fillers, plasticizers, wetting agents, defoamers, anticaking agents, colloids, and water soluble natural and synthetic polymers. Methods for producing powdered adhesives are known in the art, and include the drying of a liquid adhesive formulation by spray-drying, oven drying, drum drying, freeze drying, atomization, and fluidized bed drying. The powder adhesive formulation may also be blended from dried components.

Polymers useful in the powder adhesive formulation include both natural and synthetic polymers. Useful natural polymers include, but are not limited to, starches and modified starches, gums, pectin, dextrin, cellulosics, casein, and gelatin.

Useful synthetic polymers may be any polymer that can be made into a powder and is useful as an adhesive. The polymer must be capable of being reactivated to achieve its adhesive properties. Polymers useful in the invention may be of any architecture, and may be made by known means, including solution polymerization, emulsion polymerization, suspension polymerization, and inverse emulsion polymerization. The polymer powder formulation will generally have a Tg of between −60° C. and +40° C., preferably from −50° C. to +40° C., more preferably from 40° C. to +35° C. and most preferably from −20° C. to +35° C. One in the art will recognize that the Tg of a polymer may be adjusted through the use of tackifiers, plasticizers, and other additives to adjust the Tg of the entire polymer powder formulation to the ranges stated above. The polymer may be a homopolymer, or may be formed from two or more monomers. It may contain functional monomers, and reactive monomers such as silanes, and may also contain some crosslinking monomers. Polymers having heat activated functional groups, such as epoxy, polyester, or polyamide group are useful. Polymers containing pH activated groups may also be used. Polymers activated by pH include, but are not limited to, NR₃H⁺ compounds; silane that can form a silanol group; an epichlorhydrine group forming an epoxide; and a N-methylol acrylamide plus an acid to yield a compound which is crosslinkable with cellulosics.

One particularly useful group of polymers are those that are cationic. Cationic polymers include those containing cationic-functional monomer units, and those formed using cationic surfactants. In one embodiment of the invention, a cationic monomer is polymerized into the polymer. Examples of cationic monomers useful in the invention include, but are not limited to, N-3-(trimethyl ammonium) propylchloride; N, N—[3-(chloro-2-hydroxypropyl)-3-dimethyl ammonium propyl)]methacrylamide chloride where the alkyl groups are independently C₁₋₁₈. Other useful monomers become cationic at low pH, such as N,N dialkylaminoalkyl(meth)acrylate, N,N dialkylminoalkylacrylate, dialkylaminoalkyl(meth)acrylamide, and N,N dialkylminoalkylacrylamide. Aromatic amine containing monomers such as vinyl pyridine may also be used. Furthermore, monomers such as vinyl formamide, vinylacetamide etc that generate amine moieties on hydrolysis may also be used. Preferably the hydrophilic acid-neutralizable monomer is N,N-dimethylaminoethyl methacrylate, and N,N-dimethylaminopropyl methacrylamide.

Cationic monomers that may be used include the quaternized derivatives of the above monomers as well as diallydimethylammonium chloride, methacrylamidopropyl trimethylammonium chloride. The cationic monomer is present in the polymer at from 0.5 to 50, preferably from 1 to 30 percent by weight based on the total monomer.

In another embodiment, a cationic charge is incorporated onto the polymer by the use of a cationically charged protective colloid, such as cationic polyvinyl alcohol. The advantage of this composition is that the cationic charge is concentrated onto the surface of the polymer particle. The cationic colloidal stabilizer is present in the polymer at from 2 to 50, preferably 3 to 25 weight percent based on the total weight of monomers.

In one embodiment the cationic polymer is a cationic core shell polymer, such as a cationic shell-acrylic core or polyvinyl alcohol shell-ethylene vinylacetate core. A method for making these polymers is found in WO 00/05275.

The polymer powder may also contain a charge control agent that will allow the adhesive powder to get fixed to the substrate for a long period of time, enabling a safe cure when required.

The powder adhesive polymer formulation is applied to a non-metallic substrate. Examples of non-metallic substrate useful in the present invention include, but are not limited to wood, glass, paper, leather, paperboard, card board, corrugated board, cellulose, and plastics, wovens and non-woven materials.

The powder adhesive formulation is applied to the non-metallic substrate by applying a static charge to the powder particles in a high voltage electric field and depositing the charged particles onto the substrate. The static charge is typically applied at about 5 to 90 Kvolts, preferably about 60 Kilovolts. All powder adhesives tested were able to stick to paper or plastic once passed through the corona field.

An electrostatic charge is imparted to the polymer particle by any of several different means. Xerography techniques are useful for applying the powder to the substrate. Xerography techniques include, but are not limited to mono-component charging systems such as Torrey Pines Research's dry roller coating system Corona Electrostatic Roll and Transport (CERT) and dual-component charging devices such as DSM Coating Electro-Magnetic-Brush are useful for applying the powder to the substrate. Corona or Tribo charging guns, known in the art may be used. Because there is no contact, and therefore no friction, Torrey Pines Research CERT device will work with any powder type, soft product having low Tg. The DSM system will work with harder powders having high Tg, and requires the use of carrier particles that will charge the small powder particles. Since this creates friction and heat, it will be impossible to run long hours with low Tg materials.

In one embodiment, it was observed that powders, whether cationic or non-cationic, have a longer lasting fixation on recycled paper, such as 300 gsm cardboard. In applying the powder to the substrate, it is a necessity that the receiving substrate is positioned above the metal part at mass. This means that in order to fix an electrostatic powder to any substrate one needs a counter part from the opposite sign. For instance, if powder is positively charged, the underneath of the receiving substrate should be negatively charged, and vice versa. In this manner a magnetically charged particle is attracted and fixed onto a non-conductive substrate. The change in polarity will literally drive the charged particles to the substrate.

Once the powder adhesive has been deposited onto the substrate, it remains non-tacky until activated just prior to end-use. The powdered adhesive can be activated by moisture (plasticised), heat, pH, or radiation such as IR, UV and near infra red technology (NIR), and x-ray. The fundamental properties of the adhesive, such as tack, open time, and setting speed are reactivated. The result is that the coated substrate, once activated, can bond with another substrate or with itself. The second substrate may be a non-metallic substrate or a metallic substrate.

In one embodiment, the substrate having the electrostatically-applied powder can be placed in contact with a second substrate prior to activation of the adhesive. The adhesive is then activated after the two substrate are in place, permanently adhering the substrates. This method allows the substrates to be aligned in the proper position prior to the adhesive having tacky properties.

In another embodiment, a dual spray mix may also be used to apply the powder to the substrate. The dual spray mix employs either a charging gun (Tribo or Corona), or a venturi nozzle system to spray powder to a substrate while at the same time spraying a fine mist of water activating the adhesive. The dual system could also be a micro-batch chamber made of a double input of powder and water, dispatching both materials into the chamber, where a screw and ailettes mixes the product before it is sprayed onto a substrate. In a dual spray system the powder is activated at the same time it is being electrostatically applied and the adhesion due to the electrostatic charge is augmented by the adhesive properties of the activated adhesive powder. Additionally, the water mist could be pH adjusted with an acid or base, in a manner to activate a pH-activated polymer forming reactive bonds for improved adhesion. The mist could also contain wetting agents or other additives to aid in adhesion, wetting and/or reactivation of the powder adhesive.

It was observed that the charge of a cationic acrylic formulation, does not last longer than a polyvinyl alcohol (PVOH) post-added ethylene/vinyl acetate (EVA) formulation. The cationic polymer does not seems to have an effect in terms of better charge-ability. However, a cationic shell-acrylic core powder does re-activate faster than a PVOH shell-EVA core formulation. It is believed that a powder made of an EVA core and a natural polymer shell such as starch or dextrin will activate better than a PVOH shell-EVA core, and as well as a cationic shell-acrylic-core. This could have a huge potential in terms of water activation applications.

The deposition of a powder adhesive onto a non-metallic substrate may be used in many different manufacturing processes. These include, but are not limited to labeling, especially for glass and plastic containers such as bottles; envelopes and pocket manufacturing; tobacco; book binding; folded boxes and glue lap; flexible laminating; bags and sacks; litho-laminating and assimilated such as in foil or file manufacturing; and in the paper conversion industry, such as in tube winding, core winding, and composite boxes.

Advantages of the adhesive powder-coated substrates are: reduced coat weight, reduced down time, the reduction of complex processes, elimination of a liquid adhesive applied during production, adhesive can be applied on the entire surface, or in a specific pattern, the adhesive formulation may be simplified, and the use of less water in the manufacturing process resulting in faster manufacture and a more environmentally-friendly process.

The process of the invention can reduce the coating weight of adhesive. It is possible to fix a powder at a coating weight, or thickness below 10 microns, compared to typically liquid adhesive use at from 15 to 30 microns dry.

Down-time at the manufacturing site can be significantly reduced, since the adhesive powder can be pre-applied, and activated just prior to use. This eliminates costly clean-up in an operation using a liquid adhesive, such as cleaning due to splashing and throwing, and the removal of dried adhesive from coating systems and machine parts.

The use of the pre-applied powder adhesive eliminates the need for a liquid adhesive being applied during production. Labels for use on glass or plastic can be pre-coated with a powder, activated by water, near-IR, or heat at the point of application, just before being pressed onto a bottle.

The powder adhesive process of the invention can replace a complex process, such as a flexible laminating process in which a plastic is bonded to a cardboard. The powder adhesive is transparent and is not water or moisture sensitive or tacky, once heated above 70° C.

Since the powder adhesive is applied electomagnetically, it can be applied to either the whole surface, or to a selectively charged surface, reducing the total adhesive usage.

The use of the powder adhesive could serve to simplify the adhesive formulation, since properties such as viscosity, solids, and rheology would need to be less considered, or differently. These properties are key parameters that must be optimized in the application of a liquid adhesive.

The use of the powdered adhesive also results in the use of less water in the manufacturing process resulting in faster manufacture and a more environmentally-friendly process. The amount of water required to activate the adhesive is significantly lower than the amount of water in a current liquid adhesive. This means that less time and energy is required for the removal of the water during cure, and there is less waste water generated.

The following examples are presented to further illustrate and explain the present invention and should not be taken as limiting in any regard.

### EXAMPLE 1

### Method for Depositing the Powder Adhesive onto the Substrate

The following procedure was used in Examples 2-4 to deposit the powder adhesive onto a substrate:

The receiving substrate was positioned on a metal plate at mass to attract charged powder particles. The substrate was charged with powder through a Corona charging gun from ITW Gema. The substrate with attached powder is then removed from the metal plate, at which time the powder particles are still fixed, even though a loss of charge occurred. It was noted that when the charged substrate was maintained onto the conductive metal plate, the charge lasted for a longer period of time. The substrate with charged powder was then weighted to control coat weight, typically 7 gsm, then positioned on the laboratory table. Water was sprayed onto the fixed powder. The second substrate was then positioned and pressed.

### EXAMPLE 2

A polymer powder having a polyvinyl alcohol shell and an ethylene-vinyl acetate core (ELOTEX 50E100 available from ELOTEX AG) was deposited onto a white A4 size 80 gsm paper through a Corona charging gun from ITW Gema. The powder particles stayed fixed for 60 to 90 seconds, time during which a fine mist of water has been sprayed (from a Vittel spray bottle). It was noted that the water mist did not move nor remove the powder particles from substrate.

A second A4 80 gsm paper was then pressed onto the water-activated powder, and allowed to stand without additional pressure for 2 minutes. Adhesion, as visualized by fiber tears, was seen after 2 minutes, when the two substrates were pulled apart.

### EXAMPLE 3

A polymer powder having a cationic shell and an acrylic core (ELOTEX Flex 8300) was deposited onto a 300 gsm black card board through a ITW Gema Corona charging gun. The powder particles stayed fixed for 60 to 90 seconds, time during which a fine mist of water has been sprayed (from a Vittel spray bottle). It was noted that the water mist did not move nor remove the powder particles from substrate. A white A4 80 gsm paper was then pressed onto the water-activated powder, and allowed to stand without additional pressure for less than two minutes. Adhesion, as visualized by fiber tears, was seen after 2 minutes, when the two substrates were pulled apart.

### EXAMPLE 4

A polymer powder having a polyvinyl alcohol shell and an ethylene-vinyl acetate core was deposited onto a white A4 paper through a ITW Gema charging gun. The powder particles stayed fixed for 60 to 90 seconds, time during which a fine mist of water has been sprayed (from a Vittel spray bottle). It was noted that the water mist does not move nor remove the powder particles from substrate. It was noted that the water mist did not move nor remove the powder particles from substrate. A second white A4 80 gsm paper was then pressed onto the water-activated powder, and allowed to stand without additional pressure for less than two minutes. Adhesion, as visualized by fiber tears, was seen after 2 minutes, when the two substrates were pulled apart.

### EXAMPLE 5

A heat sensitive polymer powder could be applied to paper by the method of Example 1. It would be expected that the adhesive would be activated by heat, contacted with a second substrate, and would form an adhesive bond.

### EXAMPLE 6

Two heat sensitive powders, one an epoxy and one a hybrid of epoxy and polyester—from Tiger AG, were applied to plastic labels by the method of Example 1. The labels were then heated up to 120° C. for 1 minute. The powder-coated labels were then allowed to cool for 15 minutes. Once cold, fused powder was very visible giving a grainy appearance to the coating, however fixation was very stable and remainded stable of over 6 months. A label with hot fused powder was pressed onto a glass bottle and allowed to cool for 24 hours. A cold coated label was re-activated at 120° C. and positioned onto a glass bottle, and allowed to cool for 24 hours. In each case adhesion performances are extremely good, the label does not separate from bottle.

### EXAMPLE 7

The polymer of Example 4 was applied to a plastic label by the method of Example 1. The label was then applied to paper, as in Example 2. Adhesion, as visualized by fiber tears, was seen after 2 minutes, when the two substrates were pulled apart.

What is claimed is:

1. A method for electrostatically applying a powder adhesive formulation to a non-metallic substrate comprising:
a) forming a powder adhesive composition comprising a polymer:
b) applying an electrostatic charge to the powder;
c) depositing the charged powder onto a non-metallic substrate,
wherein the electrostatically-applied adhesive is capable of being reactivated and used as an adhesive.

2. The method of claim 1 wherein said polymer is a natural polymer, a synthetic polymer, or a mixture thereof.

3. The method of claim 1 wherein said polymer comprises cationic functionality.

4. The method of claim 1 wherein said substrate is selected from the group consisting of wood, glass, paper, leather, paperboard, card board, corrugated board, cellulose, plastics, wovens, and non-woven materials.

5. A method for bonding a non-metallic substrate to another substrate comprising:
a) forming a powder adhesive formulation comprising a polymer:
b) applying an electrostatic charge to the powder adhesive formulation;
c) depositing the charged powder onto a non-metallic substrate, activating said powder adhesive formulation, and contacting the activated adhesive-containing non-metallic substrate with a second substrate;
d) allowing the adhesive between the two substrates to cure, producing bonded substrates.

6. The method of claim 5 wherein the steps of step c) are performed in the order of activating the powder adhesive at the same time as it is being deposited onto a non-metallic substrate, then contacting the activated adhesive-containing non-metallic substrate to a second substrate.

7. The method of claim 5 wherein the steps of step c) are performed in the order of depositing the charged powder onto a non-metallic substrate, contacting the adhesive-containing non-metallic substrate to a second substrate, then activating said powder adhesive formulation.

8. The method of claim 5 wherein said second substrate is a non-metallic substrate.

9. The method of claim 5 wherein said second substrate is a metallic substrate.

10. The method of claim 5 wherein said activation of the powder adhesive comprises contacting the adhesive with a water mist, heat, or radiation.

11. A powder adhesive coated non-metallic substrate comprising a non-metallic substrate having directly deposited thereon by electrostatic forces, a powder adhesive capable of being activated to exhibit adhesive properties.
